(19) United States
(12) Patent Application Publication
(10) Pub. No.: US 2010/0290651 A1
(43) Pub. Date: Nov. 18, 2010

(54) PULSE STIMULATION GENERATION METHOD

(75) Inventors: David Bruce GRAYDEN, Parkville, VIC (AU); Daniel TAFT, Malvern East, VIC (AU); Anthony Neville BURKITT, South Yarra, VIC (AU)

Correspondence Address: DAVIS & BUJOLD, P.L.L.C., 112 PLEASANT STREET, CONCORD, NH, 03301, US

(73) Assignees: THE UNIVERSITY OF MELBOURNE, Parkville, Victoria (AU); THE BIONIC EAR INSTITUTE, East Melbourne, Victoria (AU)

(21) Appl. No.: 12/740,495

(22) PCT Filed: Oct. 31, 2008
(86) PCT No.: PCT/AU2008/001626

§ 371 Date: Apr. 29, 2010

(30) Foreign Application Priority Data
Nov. 1, 2007 (AU) 2007906009
May 22, 2008 (AU) 2008902532

(51) Int. Cl. H04R 25/00

(52) U.S. Cl. 381/312

(57) ABSTRACT

A method of generating stimulation pulses for application by an auditory prosthesis. The method comprises: processing an audio input to obtain time shifted frequency data in which frequency data of one or more frequencies is temporally shifted relative to one or more other frequencies, the time shifted frequency data of each frequency representing the variation in energy at the frequency over time, and generating stimulation pulses to be applied by the auditory prosthesis from the time shifted frequency data.

### FIELD

The present invention relates to a method of generating stimulation pulses for an auditory prosthesis as well as an auditory prosthesis, auditory processing circuitry and computer program code embodying the method.

### BACKGROUND

Cochlear implants encode sounds into a sequence of electrical pulses for direct stimulation of the auditory nerve in the severely and profoundly deaf.

The normal inner ear (cochlea) performs a frequency decomposition of sound, mapping the spectrum to a neural place code that is ordered by frequency (tonotopic). While current cochlear implants successfully exploit the tonotopic place code, users of cochlear implants still experience difficulties. For example, while cochlear implant users often have good speech perception in favourable listening conditions, their performance falls more markedly in noise than for normal hearing people.

Previous attempts at noise reduction tend to be grounded in sound engineering, utilizing techniques such as spectral subtraction, adaptive gain control or similar.

There is a need for an improved technique for applying stimulation pulses with a cochlear implant.

### SUMMARY OF THE INVENTION

In a first aspect, the invention provides a method of generating stimulation pulses for application by an auditory prosthesis, the method comprising:

processing an audio input to obtain time shifted frequency data in which frequency data of one or more frequencies is temporally shifted relative to one or more other frequencies, the time shifted frequency data of each frequency representing the variation in energy at the frequency over time; and

generating stimulation pulses to be applied by the auditory prosthesis from the time shifted frequency data.

In an embodiment, the stimulation pulses are for application to the cochlea.

In an embodiment, the method comprises processing the audio input to obtain time shifted data in the form of delayed frequency data in which frequency data of lower frequencies is delayed relative to frequency data of higher frequencies.

In an embodiment, the method comprises processing the audio input to obtain time shifted data in the form of delayed frequency data in which frequency data of higher frequencies is delayed relative to frequency data of lower frequencies.

In an embodiment, the method comprises processing the audio input to obtain time shifted data in the form of mixed delay frequency data in which frequency data of at least one lower frequency is delayed relative to frequency data of at least one higher frequency and frequency data of at least one higher frequency is delayed relative to frequency data of at least one lower frequency.

In an embodiment, the audio signal is processed to obtain frequency data for each of a plurality of frequencies, the frequency data of each frequency representing the variation in energy at the frequency over time and applying delays to the frequency data to form the delayed frequency data.

In an embodiment, the delayed frequency data is formed by applying time delays to the frequency data of at least some of the frequencies.

In an embodiment, larger delays are applied to lower frequency data.

In an embodiment, the delayed frequency data models the expected delay of traveling waves of the basilar membrane as sensed at spiral ganglion cells.

In a second aspect, the invention provides a method of generating stimulation pulses for application to a cochlea comprising processing an audio input to produce stimulation pulses to be applied by a plurality of electrodes, the processing including applying a traveling wave delay that models the delay at spiral ganglion cells at a point in the processing prior to the application of pulses by the electrodes.

In an embodiment, the processing is fixed rate processing and the point of application is prior to encoding electrode stimuli.

In an embodiment, the processing is variable rate processing and the point at which the traveling wave delay is applied is subsequent to encoding electrode stimuli.

In an embodiment, the processing is variable rate processing and the point at which the traveling wave delay is applied is prior to encoding electrode stimuli.

In a third aspect, the invention provides computer program code which when executed implements the above methods.

In a fourth aspect, the invention provides processing circuitry for an auditory prosthesis, the processing circuitry arranged to generate stimulation pulses for application by the auditory prosthesis by:

processing an audio input to obtain time shifted frequency data in which frequency data of one or more frequencies is temporally shifted relative to one or more other frequencies, the time shifted frequency data of each frequency representing the variation in energy at the frequency over time; and

generating stimulation pulses to be applied to by the auditory prosthesis from the time shifted frequency data.

In a fifth aspect, the invention provides processing circuitry for an audio prosthesis, the processing circuitry arranged to generate stimulation pulses for application to a cochlea by processing an audio input to produce stimulation pulses to be applied by a plurality of electrodes, the processing including applying a travelling wave delay that models the delay of travelling waves of the basilar membrane as sensed at spiral ganglion cells at a point in the processing prior to the application of pulses by the electrodes.

In a sixth aspect, the invention provides an auditory prosthesis.

### BRIEF DESCRIPTION OF THE DRAWINGS

Exemplary embodiments of the invention will be described in relation to the following drawings in which:

FIG. 1 illustrates a travelling wave delay discrepancy between a spiral ganglion cell model and a basilar membrane model;

FIG. 2 is a block diagram of processing circuitry;

FIG. 3 is a flow chart showing the methods of the preferred embodiment;

FIG. 4 is a block diagram of an auditory prosthesis;

FIG. 5 illustrates an implanted auditory prosthesis;

FIG. 6 is a graph of sample travelling wave delays;

FIG. 7 is a graph of test results in noise;

FIG. 8 is a graph of further test results;

FIG. 9 is a graph of speech perception in quiet;

FIG. 10 shows a spectrogram of the word “asa” with an exaggerated (for visualisation) travelling wave delay employing the methods of the preferred embodiment;

FIG. 11 is a spectrogram of the word “asa”;

FIG. 12 is a graph showing that other types of delays may be applied;

FIGS. 13A and 13B show the information presented on electrodes for the word “asa” without and with a travelling wave delay;

FIGS. 14A and 14B show the information presented on electrodes for the word “loud” without and with a travelling wave delay; and

FIG. 15 is a further graph of travelling wave delay sensitivity.

### DETAILED DESCRIPTION

### Overview

Embodiments of the invention provide two methods which provide improvements to existing signal processing techniques for auditory prostheses such as cochlear implants.

The first method is to apply a time shift to data representing different frequencies before the stimulation pulses are generated from the data. The generation of stimulation pulses involves converting an acoustic waveform into electrical pulse levels (mapping) and deciding the times of stimulation (temporal arbitration). This arbitration is sometimes considered a separate stage, often whereby the N largest pulses are selected and the rest discarded (maxima selection). The time shifting can occur after mapping but needs to be before any arbitration/maxima-selection/pulse-discarding stage.

The first method can be applied in processing schemes that use either fixed or variable stimulation rates but is particularly advantageous in fixed-rate stimulation schemes as a time shift can be introduced without introducing contention. Herein a reference to a frequency will be understood to be a reference to a frequency band.

The implementation of the time shift prior to determining which of the stimulation pulses are to be delivered to the cochlea is believed to reduce the possibility of a “bottleneck” resulting in information being discarded.

Certain features of sounds often occur simultaneously across frequency bands (e.g. a fluctuation in amplitude) and only a certain number of frequency bands can be presented intelligibly to the brain at one instant which results in some information being discarded in current processing schemes. This method involves slightly offsetting some of the information from other information in time. That is, to introduce a relative delay between some information carrying components rather than cancelling them. One way this can be achieved is to introduce a travelling wave delay, arranged to mimic the normal cochlea where low frequency sounds are sensed later in time than high frequency sounds because they have further to travel along the cochlea partition. However, with the processing circuitry of a prosthesis, it is possible to shift frequency bands in a number of patterns to manage the bottleneck.

Current cochlear implants do not address this bottleneck problem and sometimes discard frequencies with data of smaller energy when too many frequencies are present in a sound at one instant, and do not use a travelling wave delay. We suspect that this is because in the fixed rate processing schemes currently deployed in cochlear implants, introducing different delays to individual stimulation pulses will introduce contentions between the stimulation pulses of different frequencies such that it reduces the number of generated stimulation pulses that can actually be applied to the cochlea. The loss of information from applying fewer pulses is believed to outweigh any benefits that would be gained by improving the relative timing of arrival of the stimulation pulses.

A second method, suitable for application with some embodiments of the first method, is to apply a delay model that models the delay of receipt of the applied stimulation pulses at spiral ganglion cells rather than at positions on the cochlear basilar membrane.

In some embodiments, the two methods can be advantageously combined. However, they are not strictly dependent upon one another. For example, the second method can be applied without the first method in processing schemes that use a variable stimulation rate.

Form of Preferred Embodiments

The methods of the preferred embodiment will typically be embodied in the processing circuitry of an auditory prosthesis in the form of a cochlear implant. However, the methods can also be embodied as program code used to upgrade existing processing circuitry. Such program code may be supplied in a number of forms depending on how the cochlear implant is adapted to receive programming upgrades. For example, it could be supplied as a data signal written to an existing memory of a cochlear implant processor or an existing memory could be replaced with a new memory containing the program code. If the code is written to the memory it can be supplied in accordance with known techniques such as on a computer readable medium or by download from a remote computer. The actual program code may take any suitable form and can readily be produced by a skilled programmer from the following description of the methods.

Conversion of Sound Waves to Neural Signals by Normal Cochlea

The human inner ear (cochlea) is a spiral structure which encodes sound vibrations into electrical signals for the auditory (hearing) nerve. In normal hearing, sound vibrations reach the cochlea and cause displacement of the basilar membrane within the cochlea. This membrane has a graded stiffness, with high frequency sounds resonating near the basal entrance, and low frequency sounds resonating towards the apical end. Complex sounds are thus spectrally analyzed through mechanical frequency decomposition.

Auditory nerve fibres (also called spiral ganglion cells) each associate with different regions of the cochlea via the Organ of Corti. These spiral ganglion cells are thus mapped with a place code which is tonotopic. Each nerve fibre is associated in the brain with a particular frequency of sound due to this mapping. Other factors can influence the pitch perceived from a given nerve cell, such as the periodic timing of nerve signals.

How Cochlear Implants Mimic this Transduction Process

Severe and profound deafness occurs when the auditory nerve receives little or no acoustic-to-electric transduction from the cochlea. A cochlear implant is a device that restores hearing in severely and profoundly deaf people through direct electrical stimulation of the auditory nerve. An electrode array is surgically inserted into the cochlea such that each electrode stimulates a different place in the cochlea.

The brain's place coding of sound is exploited by the cochlear implant speech processor. It captures sound through a microphone, applies frequency decomposition using a filter bank or other method, and maps the outputs of each frequency channel to the implanted electrodes in a tonotopic manner.

Traveling Waves

Since high-frequency sounds vibrate the cochlear basilar membrane near the entrance (at the base) and low-frequency sounds must travel progressively deeper into the spiral (to the apex), there exists a delay that is a function of frequency; i.e. low-frequency sounds are delayed relative to high frequency sounds. This manner of sound propagation or group delay along the basilar membrane is called a traveling wave.

Method 2

As indicated above, in embodiments of the first method which involves the application of a frequency dependent delay prior to generation of the stimulation pulses can be advantageously combined with a second method of applying a delay that models delay of travelling waves of the basilar membrane as sensed at spiral ganglion cells. It is convenient to describe the delay model (or second method) before describing how it is applied.

The terms ‘distance along the basilar membrane’ and ‘frequency’ are interchangeable since they are related by Greenwood's equation:

F(x)=165.4(10̂(2.1x)−0.88) Equation 1

where F is frequency (Hz), and x is normalized distance (0 to 1) from the cochlea apex. This can be inverted to give x(F)=log 10((F+0.88)/165.4)/2.1.

Traveling wave delay equations as a function of distance take a variety of similar forms. Travelling wave delays have been described in a number of publications. A recent equation described in Donaldson, G. S. and R. A. Ruth (1993), “Derived Band Auditory Brain-Stem Response Estimates of Travelling-Wave Velocity in Humans.1.Normal-Hearing Subjects.” Journal of the Acoustical Society of America 93(2): 940-951, is:

L(d)=0.3631exp(0.11324d) Equation 2

where L is the latency (milliseconds) and d is the distance (mm) from the base of the cochlea.

Traveling wave delays have traditionally been calculated as a function of distance along the basilar membrane. However, the stimulating electrodes in a cochlear implant target the spiral ganglion cell bodies directly, which are in Rosenthal's canal, not on the basilar membrane. These electrically stimulated spiral ganglion cell bodies lie below the inner hair cells from which their dendrites normally synapse. Thus, they receive input from a lower frequency locus than would be expected from their position.

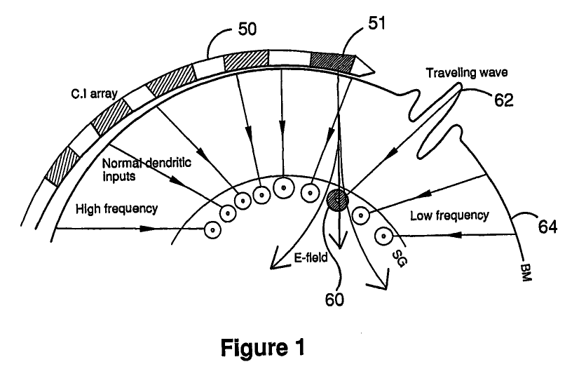

The anatomical reason for this is that the spiral ganglion turns on a smaller radius than the Organ of Corti and terminates sooner at both ends. Normally the nerve fibre inputs take a tangential course from the Organ of Corti to the modiolus. FIG. 1 shows that a given electrode 51 of electrode array 50 stimulates a spiral ganglion cell 60 that normally corresponds to a travelling wave 62 further along the basilar membrane 64. This is readily observed experimentally where a place-pitch percept for an electrode is usually found to be lower than predicted by insertion depth and Greenwood's function.

In FIG. 1, the filled spiral ganglion cell 60 is stimulated by the electrode 51. In normal hearing, this cell would normally have received input from deeper within the cochlea due to the spiral geometry. If we aim to delay the implant's electrical signal for this cell as closely as possible to the normal biological delay, then it is not the position of the electrode on the membrane that governs the delay but rather the position on the membrane which would acoustically excite the same spiral ganglion cells as the electrode now does. This can be determined in a number of ways but we employed a psychophysical approach, to, in effect, calibrate the delay for each subject. Other methods are described below.

To ascertain the actual travelling wave delays associated with a particular electrode, an electrode-pitch function was derived for each test subject. From this test set of travelling wave delays, one can choose a suitable default set for widespread use.

This method involves any form of perceptual experiment whereby the place pitch at each electrode is determined (an electrode-pitch function). This equivalent electrode frequency, f, can be put into Greenwood's equation to find a perceptual (or virtual) place, x, for each electrode.

Example procedures include pitch matching and pitch estimation. Pitch matching requires a subject with residual hearing to match the frequency of an acoustic pure tone with a pulse train on a given electrode. The pulse train must be of sufficiently high rate of stimulation (e.g. 900 pulses/sec) to avoid confounding rate cues. Pitch estimation requires subjects to assign a subjective pitch rating to pulse trains on each electrode. This subjective scale is calibrated to Hertz by repeating the procedure for pure tones observed through residual natural hearing.

The subsequent “perceptual insertion distance” for each electrode was then based on the basilar membrane locus that would normally excite these neurons (and elicit the same pitch percept), rather than the position on which the electrode lies. This perceptual place was more apical (lower pitched) than predicted by the electrode coordinates alone. It was these coordinates, based upon psychophysically perceived pitch rather than electrode place, that we used as inputs for the travelling wave equation (Equation 2).

Each electrode has a best frequency value assigned according to an associated location in the spiral ganglion cell area. This frequency value can be converted to a perceptual (or virtual) position on the basilar membrane with Greenwood's function (Equation 1), which is then fed into a travelling wave delay equation (Equation 2). This is detailed below.

Method 1

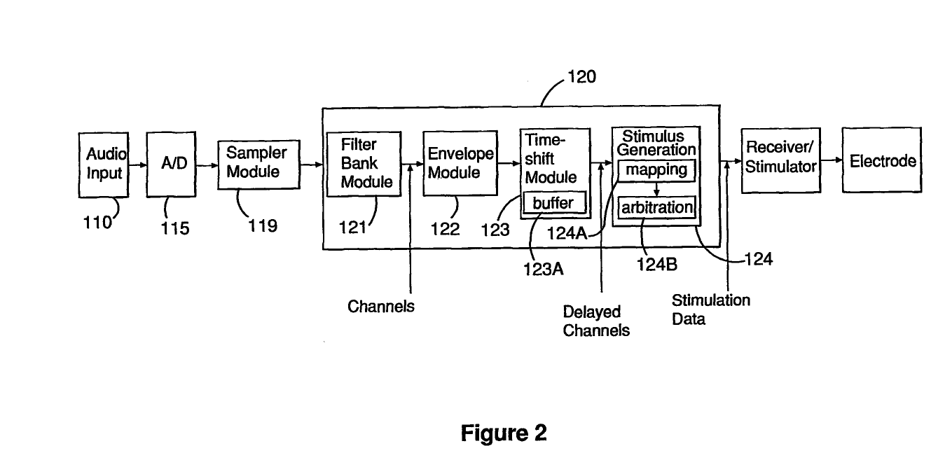

Referring to FIG. 2, there is shown an embodiment of an auditory prosthesis arranged to implement time shifted frequency data by implementing a travelling wave delay. As in existing cochlear implants, the audio input 110 is converted by an analogue to digital converter 115, processed by filter banks 121 and subjected to envelope processing 122 to produce frequency data for a plurality of different frequency ranges or channels. As in the prior art, the number of channels corresponds to the number of electrodes of the implanted cochlea implant. Unlike the prior art, a time-shift module 123 applies a travelling wave delay to the channels.

Once a travelling wave delay is set for each electrode, the filter bank outputs are stored in a buffer 123A and channels are then selectively shifted in time according to these delays (noting that for example one or more channels may not be delayed depending on the model). Subsequent processing proceeds in the same manner as prior art electrical stimulation technique employing a pulse stimulation module 124 which incorporates a mapping module 124A and an arbitration module 124B, so this inclusion is modular and computationally efficient.

One common fixed rate stimulation strategy is the Advanced Combinational

Encoder (ACE) strategy used in Nucleus speech processors. Differences from ACE are outlined here.

Step 1:

The audio signal may be sampled with highly overlapped frames, to provide finer delay resolution, by sampler module 119. A suitable frame is 128 samples at a sampling rate of 16 kHz. Subsequent frames must overlap, with a suitable overlap being 127 samples. Thus, the next frame would consist of samples 2 through 129, and so on.

Step 2:

Each frame is analyzed by the filter bank 121 and the result stored in a buffer. The filter bank analysis rate is equal to the sampling_rate/frame_shift_size. The channel outputs are delayed relative to one another (in effect by shifting them in the buffer 123A) according to the travelling wave values before down-sampling to the stimulation rate. This allows a finer resolution of delays to be applied to each channel.

Step 3:

The traveling wave delay values (in ms) can be calculated as L(c*(1−x(F))) where F is the electrode (or channel) place-pitch in Hz, x( ) is an inverse of Greenwood's function, c is the length of cochlea in mm (e.g. 35 mm) and L( ) is the delay as a function of distance from the base. This formula says that one assigns a frequency, F, to each channel (e.g. according to a model), converts it to a place in the cochlea (according to Greenwood's function, x(F)), scales it to a distance from the cochlea base, and applies a latency function L(d) to determine that channel's travelling wave delay.

Step 4:

Any pulse stimulation generation scheme 124 may then be applied after travelling wave delay inclusion. For example, maxima selection, temporal arbitration, stimulating all electrodes and/or perceptual encoding. The application of the travelling wave delay described above allows channel de-synchronization and greater information selection.

Without the overlapping-down-sampling procedure of Steps 1 and 2, delays are quantized to 1/stim_rate rather than 1/samp_rate, which may be too coarse if the stimulation rate is low.

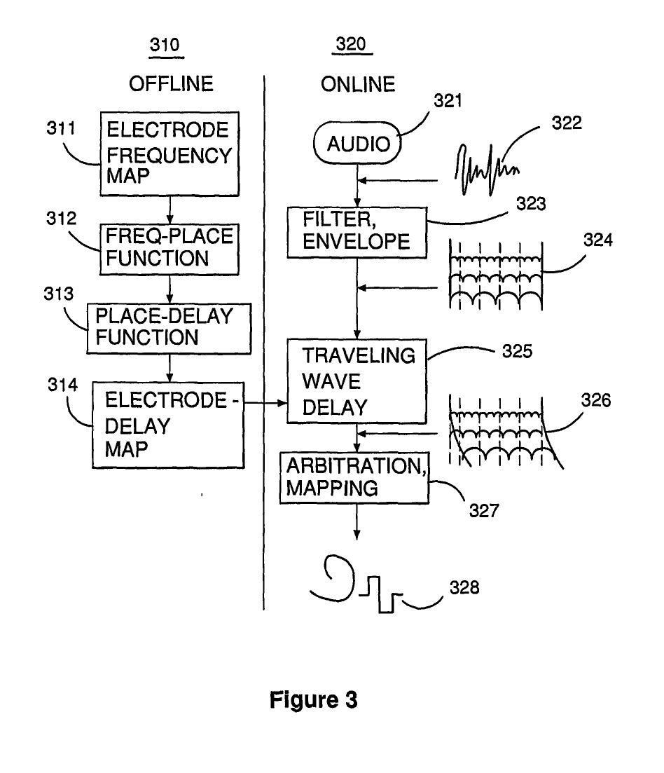

The method of the preferred embodiment is summarised in FIG. 3. An offline process 310 involves taking an electrode frequency map 311, employing a frequency place function 312 and a place delay function 313 to generate an electrode delay map 314. The online process 320 involves taking an audio input 321 having an audio waveform 322, applying filter and envelope functions 323 to produce a plurality of enveloped wave forms 324 which are frequency data for a plurality of frequencies, applying a travelling wave delay 325 to produce delayed frequency data 326 and using an arbitration and mapping technique 327 to generate stimulation pulses 328 for application to the cochlea.

Exemplary Apparatus

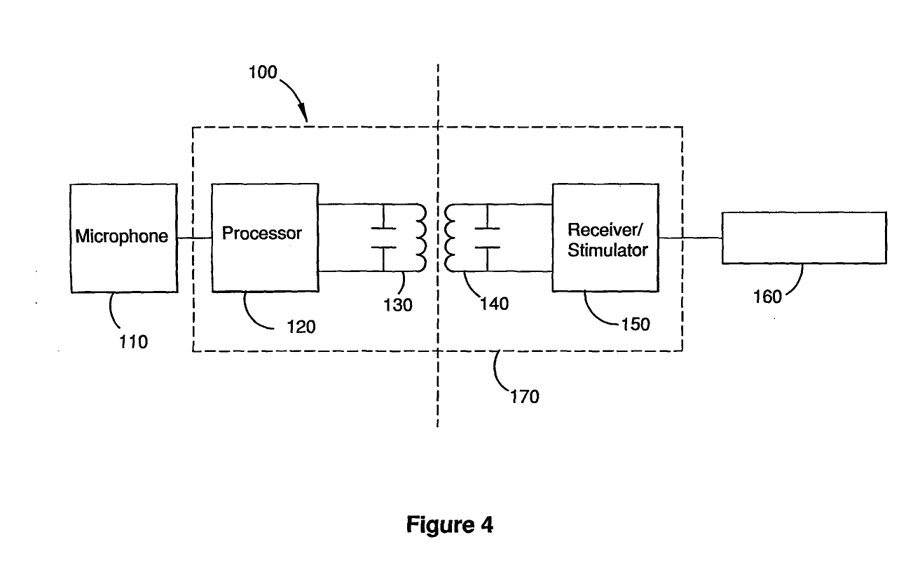

FIG. 4 shows that an auditory prosthesis 100 comprises a microphone 110 which produces an audio signal that is fed to a processor 120 and subjected to auditory processing. The output of the processor 120 is transmitted via an external coil 130 and an internal coil 140 to a receiver/stimulator 150 that outputs stimuli to a set of electrodes 160 to apply the stimuli to the cochlea of the user. Accordingly, the processor, 120, the coils, 130,140 and the receiver stimulator 150, collectively provide processing circuitry 170 for the auditory prosthesis 100.

As shown in FIG. 2, processor 120 implements the filter bank 121, the buffer 123A, and the maxima selection or temporal arbitration scheme 124.

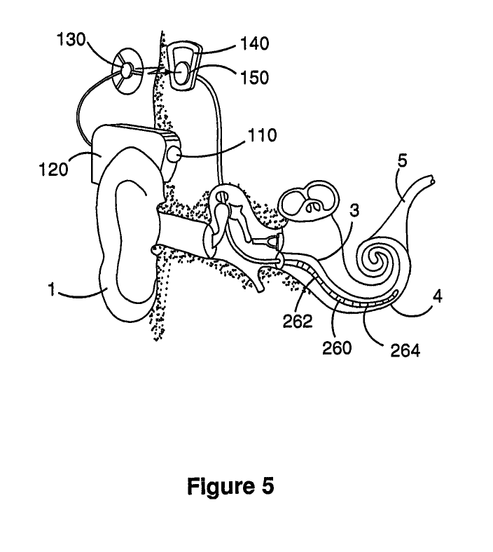

As illustrated in FIG. 5, an electrode array 260 is placed in the basal turn in the cochlea for electrical stimulation of the auditory nerve in the manner currently performed for cochlear implants. FIG. 5 shows an external processor 120 mounted behind the ear 1 of a user. Microphone 110 receives ambient sound, which is processed by the processor 120 in order to drive external coil 130. Internal coil 140 picks up the signal transmitted by the external coil 130 and receiver/stimulator 150 generates both stimuli for transmission to the electrode array 260.

While the above embodiments employ an external processor, the processor may be deployed internally in a totally implantable auditory prosthesis.

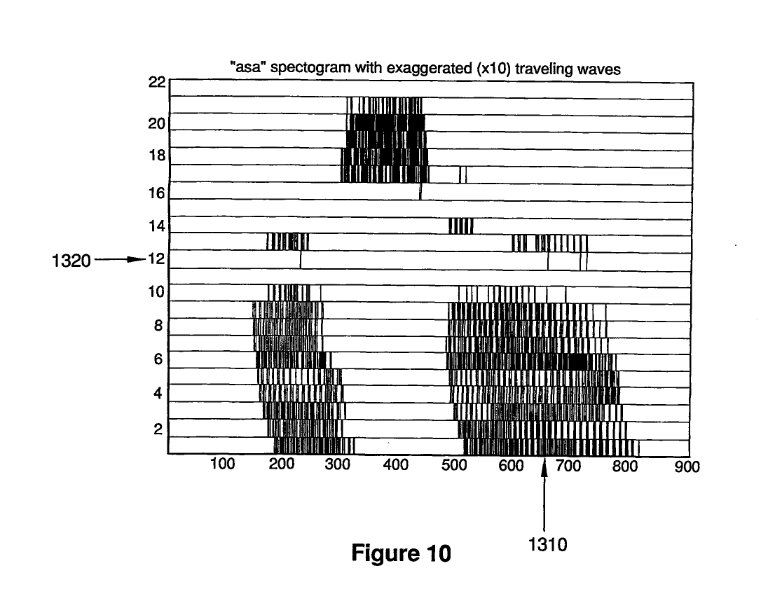

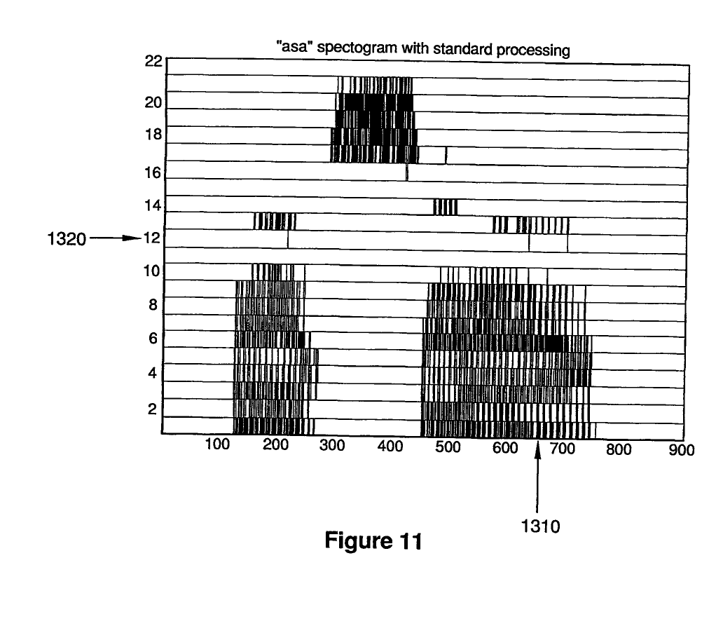

Spectrograms in FIGS. 10 and 11 show the applied travelling wave delay (exaggerated ×10 for visualization) 1310 (FIG. 10) relative to the unmodified control (FIG. 11) (1320) for an example audio token.

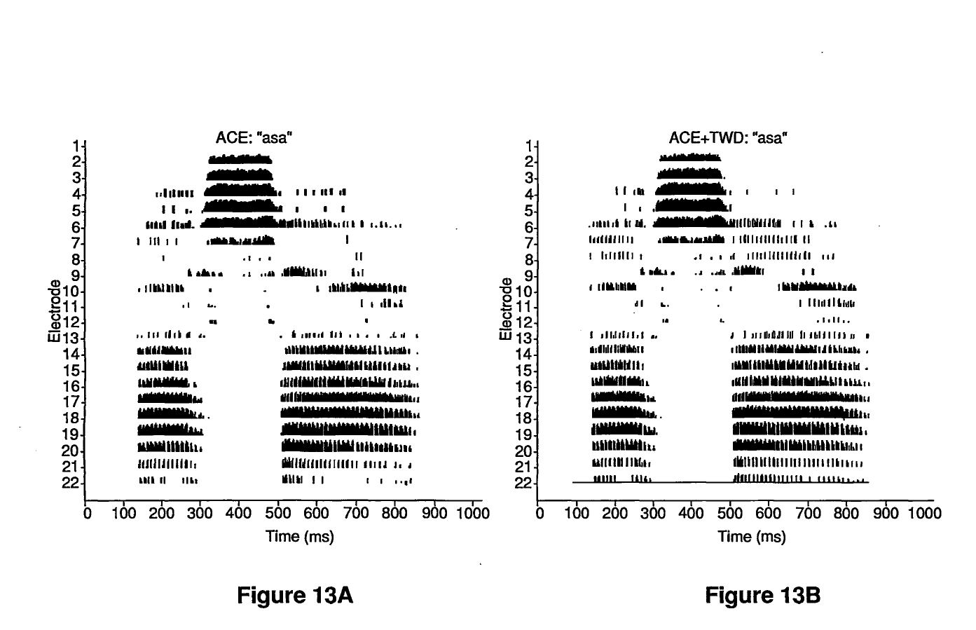

Similarly, FIGS. 13A and 13B show the information presented on electrodes for the word “asa” without (FIG. 13A) and with (FIG. 13B) a travelling wave delay. The Y-axis represents the electrode number (1 to 22) so that the amount of information delivered at different times can be seen for each electrode. From FIG. 13B it will be apparent that more information is delivered. See in particular, electrode 22.

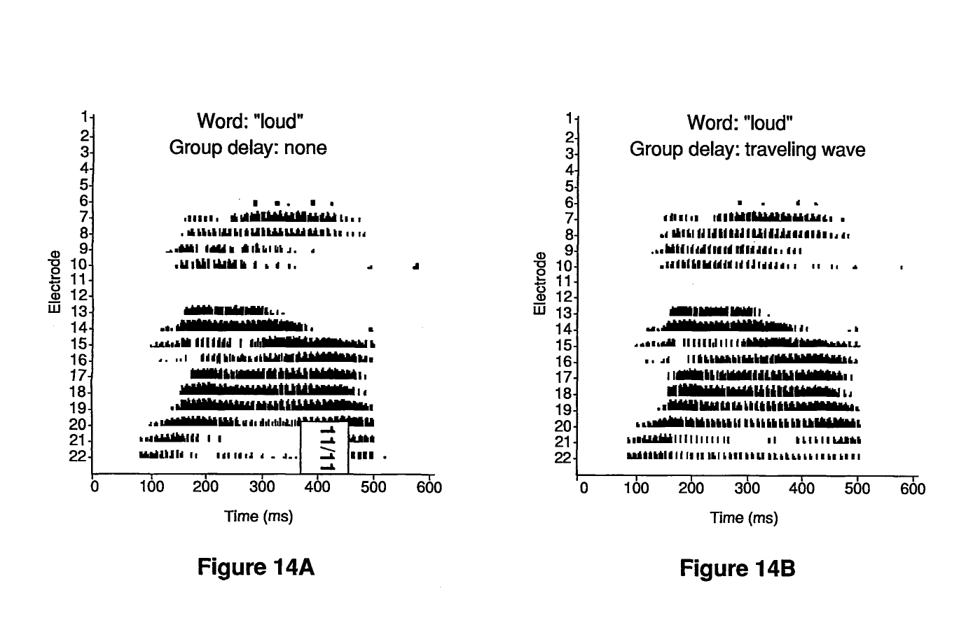

FIGS. 14A and 14B show the information presented on electrodes for another word, namely “loud” without (FIG. 14A) and with (FIG. 14B) a travelling wave delay. Again, from FIG. 14B it will be apparent that more information is delivered with the travelling wave delay. See in particular electrodes 9 and 10, the edge of the second formant (resonance) of the vowel. As in FIG. 13, these additional pulses are generated at intervals of the fundamental frequency (F0), with no calculation of F0, no amplitude gains to that channel, or indeed any arithmetic computation. A similar effect is seen on electrodes 21 and 22, the edge of the first formant.

FIGS. 13 and 14 show that about 2% more pulses are applied due to application of the travelling wave delay—i.e. an advantageous reduction in the amount of audio information discarded by the stimulation generation module 124.

### ALTERNATIVE EMBODIMENTS

Alternative Configurations of Processing Circuitry

Referring to FIG. 2 the time-shift module 123 can be inserted earlier in the chain of components 115 to 122. It can go before the envelope module 122, or even before the filter bank module 121. Though unlikely to be a viable possibility, it could also go before the ND converter 115 in some specific implementations. That is, the time-shift module 123 can be inserted anywhere before the arbitration module 124B, inside block 120. This utilises a system property (of modules 121, 122 and 123 and any other modules that may be used) known as time invariance.

The Envelope Module 122 is always interchangeable with the time-shift module 123. Placing the time-shift module 123 before and/or within the Filter Bank Module 121 is also trivial if a filter bank is the type of filter used. In this case, the input to each filter is simply delayed by an identical amount to that which the output would have been delayed.

In the event that a filter bank 121 is not used, an FFT-based filter is often used. In this case, applying the delays before the filter is possible but not preferable. The reason is that this requires more filter computations (for the same outcome) than by applying the time-shift module 123 to the audio channels after the filter.

It is particularly advantageous to apply the time-shift module 123 late in the audio processing stage. This is the easiest point of insertion for a broad range of processing strategies.

Persons skilled in the art will appreciate for the same reason that this travelling wave delay technique has been shown to be advantageous in cochlear implants, it is also likely to provide benefit in other auditory prosthesis including auditory brainstem implants (including implants in the cochlear nucleus and the inferior colliculus) and cortical implants—i.e. because the underlying cognitive routines are the same in interpreting such stimuli. The testing techniques set out below under evaluation as well as others known in the art could be used to confirm effectiveness in these and other auditory prostheses.

Alternative Time-Shifting Techniques

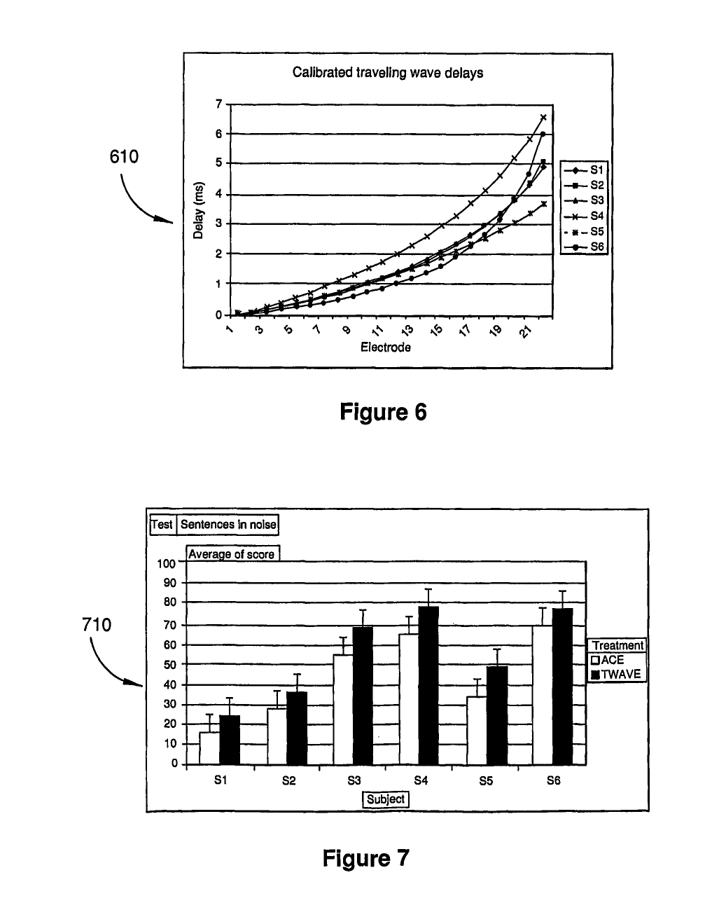

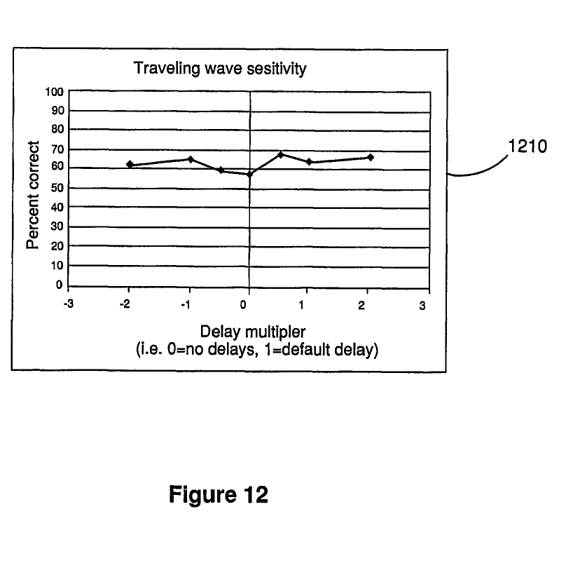

Alternative time-shifting techniques include a reverse travelling wave delay where high frequency channels are delayed relative to low frequency channel. The graph 1210 of FIG. 12 shows that time-shifts in the form of negative delays can be effective. To produce FIG. 12, a travelling wave delay (S6 on FIG. 6) was multiplied by various scalars: −2 −1 −0.5 0 0.5 1 2. Noting that ‘0’ corresponds to no delay. Speech perception was tested with each of these delays. FIG. 12 shows that the negative delays provide an improvement over no delay for the same travelling wave delay.

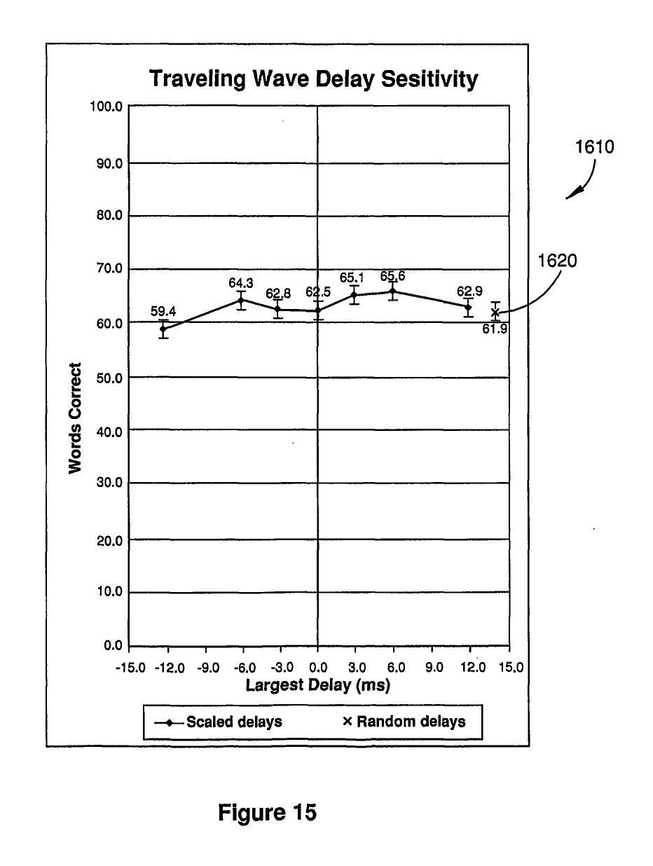

FIG. 15 shows a graph 1510 of percentage words correct (y-axis) relative to delay in milliseconds (x-axis). A result for random delays 1520 is also shown which shows that applying delays at random does not improve hearing. The graph confirms that negative delays (see, e.g. the 6 ms negative delay) provide improvement and that best results are achieved for moderate delays such as 3 ms or 6 ms

The evidence suggests that techniques can be employed where one or more lower frequencies are delayed relative to one or more higher frequencies while at the same time one or more higher frequencies are delayed relative to one or more lower frequencies. In one example, the largest delay might be applied to a frequency at random. In another example, the relative order in which frequency bands are presented might be based on analysis of the information carried by different frequencies.

Temporal shifts for each frequency can be stored as a set of times. These can be calculated offline or online and so could be static (fixed) or dynamic (varied according to an algorithm). These shifts can be applied to frequency bands at any stage of the signal processing chain before some of the frequency bands are discarded. By time-shifting frequency bands through the aforementioned bottleneck, some of the previously discarded bands are now able to be presented.

As described above, the temporal shifts for each channel can be included as part of a filtering process. In this case, the delays are built into the filters intentionally as explicit delays, extra taps and/or as higher orders. These are known as group delays.

It is advantageous if the magnitude of one or more of these time shifts is less than 40 milliseconds relative to the magnitude of one more of the other time shifts. That is, one or more frequency bands are shifted relative to other frequency bands by an amount between zero and 40 milliseconds exclusive. We believe it is particularly advantageous if the time shifts are restricted to an amount between zero and ten milliseconds.

Traveling Wave Delay

The above embodiment describes determining the travelling wave delay psychophysically. The travelling wave model for use in Method 1 may also be derived anatomically, by applying a model or by other means, as described below.

Anatomical Method:

Cochlear anatomy can be observed through non-invasive imaging such as X-rays. With X-ray imaging, the position of the electrode array can be calculated, after which a mapping can be applied to determine the delays for each channel

Using a Model or Existing Experimental Data:

This method is the least labour intensive and also the least individually tailored. A standard electrode pitch function can be used for all subjects. Such functions can be found in the following publications: Baumann, U. and A. Nobbe (2006). “The cochlear implant electrode-pitch function.” Hearing Research 213(1-2): 34-42; Boex, C., L. Baud, G. Cosendai, A. Sigrist, M. I. Kos and M. Pelizzone (2006). “Acoustic to electric pitch comparisons in cochlear implant subjects with residual hearing.” Journal of the Association for Research in Otolaryngology 7(2): 110-124. This might be adjusted for differences in gender or other such factors: Miller, J. D. (2007). “Sex differences in the length of the organ of Corti in humans.” The Journal of the Acoustical Society of America 121(4): 151-155; Sridhar, D., O. Stakhovskaya and P. A. Leake (2006). “A Frequency-Position Function for the Human Cochlear Spiral Ganglion.” Audiology & Neurotology 11(Supplement 1): 16-20.

Tuning Method:

An electrode pitch function, or the delays themselves, can be fine-tuned based on an individual's feedback. For example, with a dial or buttons, a user can adjust the settings based on their own perception or some other measurement such as speech perception/test scores. One such implementation would involve initializing a travelling wave equation for all users and fine-tuning it individually by a factor corresponding to the preferred setting.

Variable Pulse Rate Schemes

In some variable pulse rate schemes, such as where the rate of stimulation is varied according to a model of the auditory system, the point of application of the travelling wave delay may not be critical but an improvement can be had by employing the second method. This is because applying the delay after pulse generation may result in the same pulse-sequence as if it were applied before. Accordingly, such schemes in particular, the proposed STAR scheme can exploit method 2 without method 1. Details of the STAR scheme may be found in US publication 2005/192646.

It will be understood to persons skilled in the art of the invention that many further modifications may be made without departing from scope of the invention, in particular, that features of the above embodiments may be combined to form further embodiments.

Evaluation

Traveling wave delays were evaluated against control (a standard commercial strategy, i.e. delays=0) in individual subjects with a battery of speech and pitch perception tests.

The electrode-delay maps 51-56 of FIG. 6 were generated for six subjects with a cochlear implant. The axes of FIG. 6 are delay 610 in milliseconds and electrode number 620 for a 22 electrode array.

We found a statistically and clinically significant improvement in the perception of sentences in noise with travelling waves compared to without (FIG. 7). FIG. 7 shows the score 710 for the control 720 and travelling wave model 725 for a CUNY type test. Speech recognition scores for all six subjects improved, with relative improvement ranging from 11% to 47% and a mean of 29% compared to control. Absolute improvement in mean scores was 10.77 words out of 102 words per sentence list (P<0.001).

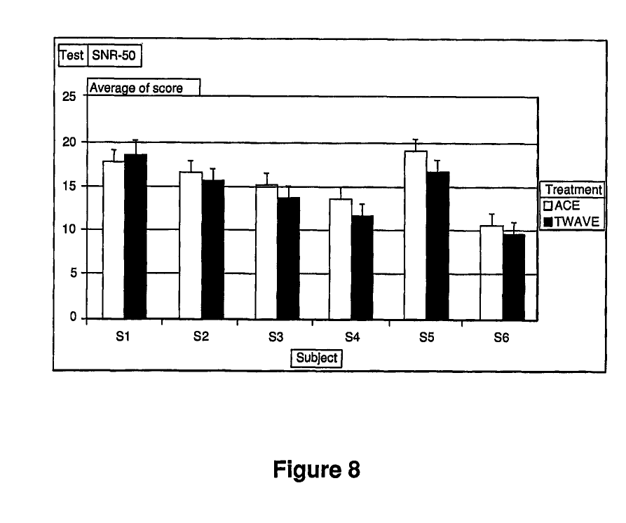

FIG. 8 confirms the improvement with BKB-SIN test, noting that a lower score in this test indicates an improved robustness to noise. Mean improvement was 1.21 dB SNR (FIG. 8; P<0.05). The BKB-SIN improvement of 1.21 dB validates the CUNY test of FIG. 7.

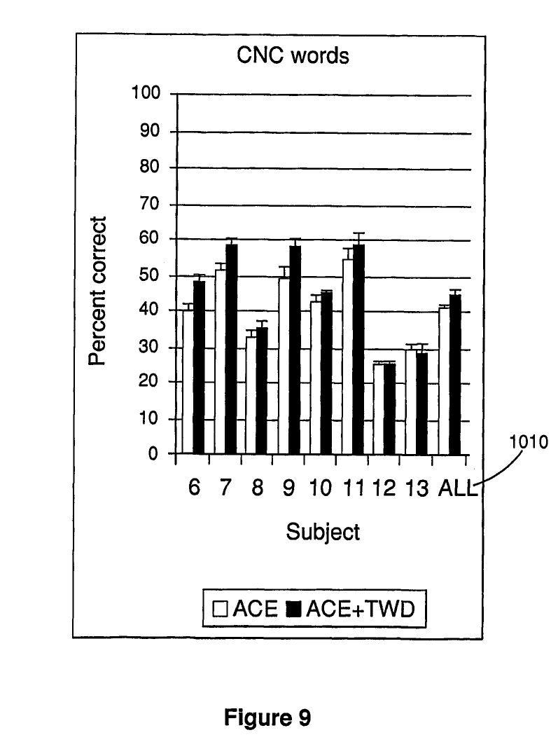

Change in scores for speech in quiet with travelling waves are shown in FIG. 9 which shows further testing conducted in respect of additional subjects using a test for CNC words in quiet. CNC words consist of three phonemes, in consonant, vowel nucleus-consonant order. The vertical axis represents the percentage of words which were heard correctly. The horizontal axis represents the subject with the combined results shown as the last bar graph. From the horizontal axis it will be noted that subject 6 was the same subject as shown in FIGS. 6 and 7, whereas the other subjects are new. The light bars represent performance without delays and the dark bars represent performance with a 6 ms delay. From FIG. 9, it will be apparent that no subjects are significantly worse off and that the average absolute improvement is 4% words correct.

Utility

Embodiments of the present invention incorporating travelling wave delays significantly improve speech perception with cochlear implants, particularly in noise. In testing, a small sample of subjects observed an average relative improvement of 29% (P<0.001) for sentence recognition scores in noise. Subjects also saw a relative 10% improvement (p<0.05) for words in quiet (see FIG. 9).

This is a new approach for improving sound perception with cochlear implants by mimicking additional characteristics of the auditory system. Our results suggest that the brain is equipped to recognize speech information that is presented in this way.

In embodiments of this invention, audio channels are first temporally offset from each other by a travelling wave equation before pulses are discarded. This is not equivalent to delaying electrode pulses immediately prior to stimulation because such a stage involves time-variant signal processing.

Embodiments of this invention require minimal changes to existing filters, processing stages and parameters to maximize the ease of implementation and minimize cost.

Interpretation

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that the reference to prior art herein does not constitute an admission that the prior art forms a part of the common general knowledge in the art any country.

1. A method of generating stimulation pulses for application by an auditory prosthesis, the method comprising:
processing an audio input to obtain time shifted frequency data in which frequency data of one or more frequencies is temporally shifted relative to one or more other frequencies, the time shifted frequency data of each frequency representing the variation in energy at the frequency over time; and
generating stimulation pulses to be applied by the auditory prosthesis from the time shifted frequency data.

2. A method as claimed in claim 1, the stimulation pulses are for application to the cochlea.

3. A method as claimed in claim 1 comprising processing the audio input to obtain time shifted data in the form of delayed frequency data in which frequency data of lower frequencies is delayed relative to frequency data of higher frequencies.

4. A method as claimed in claim 1 comprising processing the audio input to obtain time shifted data in the form of delayed frequency data in which frequency data of higher frequencies is delayed relative to frequency data of lower frequencies.

5. A method as claimed in claim 1 comprising processing the audio input to obtain time shifted data in the form of mixed delay frequency data in which frequency data of at least one lower frequency is delayed relative to frequency data of at least one higher frequency and frequency data of at least one higher frequency is delayed relative to frequency data of at least one lower frequency.

6. A method as claimed in claim 3, wherein the audio signal is processed to obtain frequency data for each of a plurality of frequencies, the frequency data of each frequency representing the variation in energy at the frequency over time and applying delays to the frequency data to form the delayed frequency data.

7. A method as claimed in claim 3 wherein the delayed frequency data is formed by applying time delays to the frequency data of at least some of the frequencies.

8. A method as claimed in claim 7, wherein larger delays are applied to lower frequency data.

9. A method as claimed in claim 3, wherein the delayed frequency data models the expected delay of travelling waves of the basilar membrane as sensed at spiral ganglion cells.

10. A method of generating stimulation pulses for application to a cochlea comprising processing an audio input to produce stimulation pulses to be applied by a plurality of electrodes, the processing including applying a travelling wave delay that models the delay of travelling waves of the basilar membrane as sensed at spiral ganglion cells at a point in the processing prior to the application of pulses by the electrodes.

11. A method as claimed in claim 10, wherein the processing is fixed rate processing and the point of application is prior to discarding electrode stimuli.

12. A method as claimed in claim 10, wherein the processing is variable rate processing and the point at which the traveling wave delay is applied is subsequent to encoding electrode stimuli.

13. A method as claimed in claim 10, wherein the processing is variable rate processing and the point at which the travelling wave delay is applied is prior to encoding electrode stimuli.

14. (canceled)

15. Processing circuitry for an auditory prosthesis, the processing circuitry arranged to generate stimulation pulses for application by the auditory prosthesis by:
processing an audio input to obtain time shifted frequency data in which frequency data of one or more frequencies is temporally shifted relative to one or more other frequencies, the time shifted frequency data of each frequency representing the variation in energy at the frequency over time; and
generating stimulation pulses to be applied to by the auditory prosthesis from the time shifted frequency data.

16. Processing circuitry claimed in claim 15, arranged to generate stimulation pulses for application to the cochlea.

17-23. (canceled)

24. Processing circuitry for an audio prosthesis, the processing circuitry arranged to generate stimulation pulses for application to a cochlea by processing an audio input to produce stimulation pulses to be applied by a plurality of electrodes, the processing including applying a traveling wave delay that models the delay at spiral ganglion cells at a point in the processing prior to the application of pulses by the electrodes.

25-27. (canceled)

28. An auditory prosthesis comprising the processing circuitry of of claim 15.

29. An auditory prosthesis comprising the processing circuitry of claim 24.

30. A tangible computer readable medium comprising program code which when executed implements the method of claim 1.

31. A tangible computer readable medium comprising program code which when executed implements the method of claim 10.
